(19) United States
(12) Patent Application Publication
(10) Pub. No.: US 2008/0046936 A1
(43) Pub. Date: Feb. 21, 2008

(54) Arrangement for Presentation of Audio-Visual Content

(76) Inventors: Aske Dam, Berger (NO); Pal Sigurd Malm, Lier (NO)

Correspondence Address: YOUNG & THOMPSON, 745 SOUTH 23RD STREET, 2ND FLOOR, ARLINGTON, VA, 22202, US

(21) Appl. No.: 11/658,040

(22) PCT Filed: Jul. 11, 2005
(86) PCT No.: PCT/NO05/00257

§ 371 Date: Mar. 12, 2007

(30) Foreign Application Priority Data
Jul. 23, 2004 (NO) 200443156

(51) Int. Cl. H04N 7/24; H04N 7/173; H04N 7/16

(52) U.S. Cl. 725/88; 725/135; 725/136; 725/102

(57) ABSTRACT

A metadata coding arrangement and a media presentation device responsive to the metadata coding arrangement provides a way for independent presentation control of a video part and an audio part of an audiovisual programme content wherein at least one of the audio part or the video part being an independently retrievable part of an electronically stored programme content. The inventive coding arrangement including the metadata having at least one of a video-only related metadata part or an audio-only related metadata part.

### 1. TECHNICAL FIELD

Local Storage, Personal Digital Recorders (PDR), Home Servers, Handheld Communication Devices etc.

### 2. TECHNICAL BACKGROUND

2.1. The Problem Area

The massive growth in the market for local storage devices like Personal Digital Recorders (set-top-boxes equipped with hard disc drives), DVD recorders, Mobile Terminals with storage capability and other personal media devices during the last six months enables a number of new features for individual media consumption. It is expected that the PDR will become a mainstream consumer device with a penetration of more than 10% of the households in the US in 2005 and in Europe the following year. It is expected that most consumer media devices of the future will feature local storage. Some forecasts point out that as much as 70% of all TV consumption will be in some kind of time-shifted mode. TV-Anytime predicted in 2000 that the storage capacity would reach 16.000 hours of video per $100 of storage medium around the year 2010, and developments so far have proven this assumption to be right.

Most digitally stored media content is time coded and can therefore be controlled very accurately by the consumer. Metadata tagging makes it possible to jump to precise locations in a programme.

The user is free to play the content in variable speeds—forwards or backwards—or freeze any frame they want but, at present, the audio and the video parts of such programmes in consumer devices are locked together and it is not possible to browse or play any of the parts independently of the other.

2.2. Known Solutions

All storage devices—analogue or digital—feature trick play (pause, variable speed forward and in rewind, freeze etc.), and a timecode stored as metadata in a digital media stream make the search functions extremely accurate. The PDR gives the consumer the freedom to watch any programme they want—anytime they want it. “Active Pause” is a new feature in PDRs where a consumer is able to pause the playback of a live broadcasting while the recording device continues to record the live programme. The content can thus be viewed in a time-shifted delay from the live broadcast.

TV-Anytime metadata provided by the broadcaster or service provider makes it possible to instantly jump back to a tagged segment—for example a goal in an ongoing football match. The consumer can review the goal and either fast forward or jump back to the live broadcasting. This has been perceived as one of the most valued user benefits of the PDR.

2.3. Problem with Known Solutions

All recording- and play-back features in known consumer devices handle the audio and the video parts of an audiovisual stream as one programme and does not allow for the user to consciously control the playback of each discrete part of a programme independently.

### 3. THE INVENTION

3.1. Description

SplitPlayVideo and SplitPlayAudio are two new platform independent features for consumer devices that allow the user to—for example—continue listening to the live audio track of a live football match, while reviewing the visual part of an episode earlier in the match. Likewise may they listen to an explanation in an educational programme for a second time, while continuing to watch the visual part of the programme live.

The SplitPlay functions are controlled by two new metadata extensions to existing industry standards—the SplitPlayVideo Action Type Classification Scheme and the SplitPlayAudio Action Type Classification Scheme. The SplitPlay extensions can control the separate audio and video streams from any digital storage device.

Live digital broadcasting can be played in SplitPlay mode through a digital storage device, which act as a buffer for the delayed component of the programme (video or audio).

Using a digital encoder and a digital storage device, even analogue programme material may use the SplitPlay features.

The use of new extensions to existing industry metadata standards to control the SplitPlay functions, make them completely platform independent. After delivery, the metadata can be decoded, transformed, parsed and validated, as necessary to control the SplitPlay playback functions of each proprietary platform. [see the TVA/ETSI specification TS 102 822-3-1 pg 77 FIG. 9]

The functionality of the system is described in the following steps:
1. This invention introduces two new concepts for user interaction with stored and broadcast audiovisual material, “SplitPlayVideo” and “SplitPlayAudio”.
2. A consumer can, for example, listen to the live audio part of a broadcasting while performing trick-play (pause, variable speed, forward and reverse) in the visual part of the recorded (buffered) programme. The user decides when and how (fast forward or jump) to return to the live (synchronized) programme.
3. The SplitPlay features use metadata, similar to those described in the MPEG7 and TV-Anytime specifications, to control the discrete parts of an audiovisual programme independently. “SplitPlayVideo” and “SplitPlayAudio” Action Type Classification Schemes are introduced to the MPEG7 and TV-Anytime toolboxes.
4. Metadata is used to activate the SplitPlay features, thus allowing the user to perform trick-play on one of the audiovisual components, while continuing normal playback of the other.
5. Segmentation metadata, containing the SplitPlayVideo code, provided by a broadcaster or service provider makes it easy to jump to, and between, precise segment starting points in the buffered visual content, while continuing to listen to the broadcast.
6. Using the SplitPlayAudio function, a user may also monitor the visual part of a programme live while listening to a buffered narration (for example listening to a commentary a second time in an educational programme). As a further feature, the audio may be played at reduced or increased speed for clarification or time saving purposes, using known pitch control.
7. In SplitPlayVideo, the video part can be presented in pre-programmed ways similar to those described in the TV-Anytime segmentation metadata specification, Highlights, Bookmarks, Previews etc. (ETSI TS 102 822-3-1), while the audio part is being presented in a continuous linear way.
8. In SplitPlayAudio, the audio part can be presented in pre-programmed ways similar to those described in the TV-Anytime segmentation metadata specification, while the video part is being presented in a continuous linear way.
9. SplitPlay may use previously inserted segment in-points for user-controlled trick-play of one of the audiovisual components—for example skip to previous or next segment in-point.
10. SplitPlay may also use user-inserted bookmarks for user-controlled trick-play of one of the audiovisual components—for example skip to previous or next bookmark.
11. SplitPlay can play one of the audiovisual components of a pre-inserted and programmed segment or segment groups, for producer- or service provider controlled playback sequences. (For example, jump back and play the last two goals in slow motion, or repeat the previous part of the narration).
12. In order to monitor the contentA
13. The delayed part of a SplitPlay may (or may not) monitor the “live” part of a programme. In the case of SplitPlayVideo by using a picture-in-picture feature and for SplitPlayAudio by using separate channels and loudspeakers.
14. Consumers who follow a TV programme while performing other tasks may use the SplitPlay function to delay the visual part in order to use the audio part to monitor “important developments” in the programme. The delay can be set individually by the user by preset skip increments (described in x/10 sec) or by using the pause and play functions. At any given point in time, they can switch back to synchronized playback.
15. Timelines and other augmentations showing the relationship between the played audio and video may be shown on the screen or on other presentation devices.

User Control Interfaces:

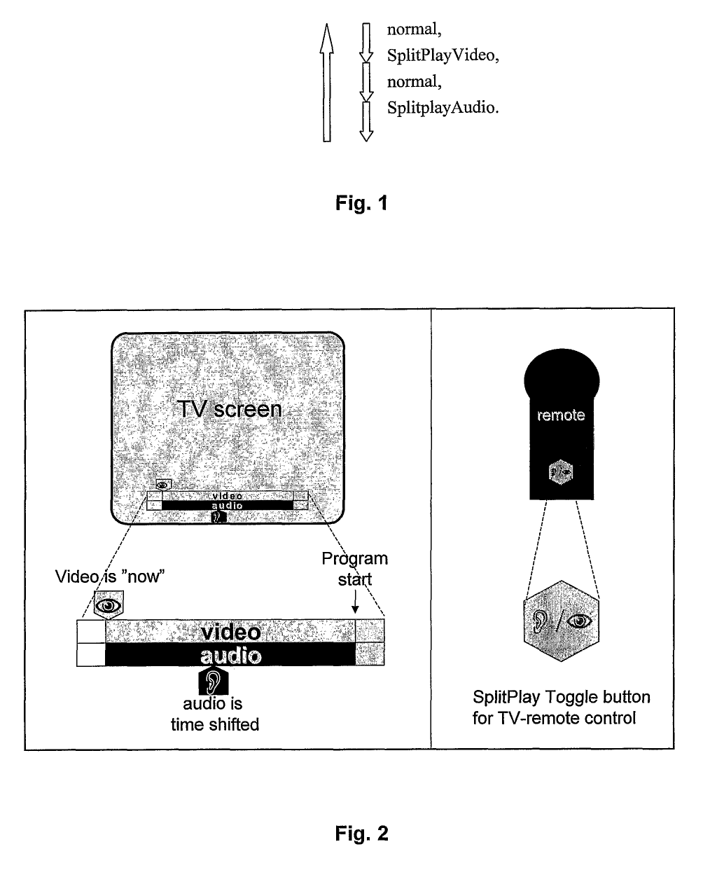

The SplitPlay can be activated by for instance a toggle switch on a remote control. The toggle has four functions in succession, as illustrated in FIG. 1.

The toggle switch may have a “right mode” and a “left mode”. During SplitPlay, a click to the right will take the consumer to “live” synchronized playback, and a left click will take them back to where they left off in SplitPlay.

In normal playback mode, the audio- and the video parts play synchronized. The trick-play buttons—Pause, Variable speed Forward and Rewind, Jump Forward or Backward to the last chapter, or to a metadata segmentation in-point set by the service provider or the user (bookmark)—control the audio and the video.

In SplitPlayVideo mode the audio is the linear playback of a live broadcast or a playback of stored content from the point the user left normal playback. Trick-play functions only control the video part.

In SplitPlayAudio mode the video is the linear live broadcast or continuous playback of stored content from the point the user left normal playback. Trick-play functions only control the audio part.

SplitPlay may also be controlled with a Graphic User Interface (GUI) on a device with a (touch sensitive) screen like a Tablet PC, PDA or mobile phone.

With reference to FIG. 2, a further explanation of the invention is provided by the following description.

In order to execute SplitPlay commands on proprietary platforms, two new sets of TV-Anytime MXL Action Type Classification Schemes have been suggested, SplitPlayVideo (5.x) and SplitplayAudio (6.x). (See Appendix A)

A SplitPlayVideo command is executed by first sending a ContPlayAudioRecordingOnly (5.17) or ContPlayAudioStreamOnly (5.18) command, followed by one of the following trickplay commands (5.1-5.16).

The Trickplay commands for video with continuous audio are:
5.1 SplitPlayVideo PlayRecording, Play video content from a recording.
5.2 SplitPlayVideo PlayStream, Play video content from input stream.
5.3 SplitPlayVideo Preview, View a video summary of the input stream.
5.4 SplitPlayVideo Pause, Pause the video input stream.
5.5 SplitPlayVideo FastForward, Fast forward the video input stream.
5.6 SplitPlayVideo Rewind, Rewind the video input stream.
5.7 SplitPlayVideo SkipForward, Skip forward over a video portion of the input stream.
5.8 SplitPlayVideo SkipBackward, Skip backward over a video portion of the input stream.
5.9 SplitPlayVideo Loop/Repeat, Repeat/loop (part of) the video input stream.
5.10 SplitPlayVideo SkipToStart, Go to the beginning of the video stream.
5.11 SplitPlayVideo SkipToEnd, Go to the end of the video stream.
5.12 SplitPlayVideo SlowMotion, View input stream in slow motion.
5.13 SplitPlayVideo StepForward, Advance to next frame.
5.14 SplitPlayVideo StepBackward, Return to previous frame.
5.15 SplitPlayVideo VolumeUp, Increase volume in continuously playing audio stream.
5.16 SplitPlayVideo VolumeDown, Reduce volume in continuously playing audio stream.
5.17 SplitPlayVideo ContPlayAudioRecordingOnly, Continue playing only audio content from a recording.
5.18 SplitPlayVideo ContPlayAudioStreamOnly, Continue Playing only audio content from input stream.

A SplitPlayAudio command is executed by first sending a ContPlayVideoRecordingOnly (6.16) or ContPlayVideoStreamOnly (6.17) command, followed by one of the following trickplay commands (6.1-6.15).

The Trickplay commands for SplitPlay Audio with continuous video are:
6.1 SplitPlayAudio PlayRecording, Play audio content from a recording.
6.2 SplitPlayAudio PlayStream, Play audio content from input stream.
6.3 SplitPlayAudio Preview, View an audio summary of the input stream.
6.4 SplitPlayAudio Pause, Pause the audio input stream.
6.5 SplitPlayAudio FastForward, Fast forward the muted audio input stream.
6.6 SplitPlayAudio Rewind, Rewind the mute audio input stream.
6.7 SplitPlayAudio SkipForward, Skip forward over an audio portion of the input stream.
6.8 SplitPlayAudio SkipBackward, Skip backward over an audio portion of the input stream.
6.9 SplitPlayAudio Loop/Repeat, Repeat/loop (part of) the audio input stream.
6.10 SplitPlayAudio SkipToStart, Go to the beginning of the audio stream.
6.11 SplitPlayAudio SkipToEnd, Go to the end of the audio stream.
6.12 SplitPlayAudio VolumeUp, Increase volume.
6.13 SplitPlayAudio VolumeDown, Reduce volume.
6.14 SplitPlayAudio Fast Playback, Fast playback of the audio input stream.
6.15 SplitPlayAudio Slow Playback, Slow Playback of the audio input stream.
6.16 SplitPlayAudio ContPlayVideoRecordingOnly, Continue playing only video content from a recording.
6.17 SplitPlayAudio ContPlayVideoStreamOnly, Continue playing only video content from input stream.

3.2. Advantages

The invention gives a consumer further control over how to use the features of a digital recorder for independent viewing and listening. None of the known consumer devices give a consumer such freedom. Because all commands are executed via standardized metadata, the SplitPlay functions will be completely platform agnostic.

### AN EXAMPLE

The TV is on in the background with a football match while a consumer is ironing their shirts. Suddenly they hear from the roar that there has been a score. They rush to the TV set, push SplitPlay button on their remote to wind the video back to the goal while the audio continues in real time in case of new episodes.

### EXAMPLE 2

While viewing an educational programme a consumer misses one of the lecturer's arguments. As if they asked their neighbor about the last argument, they press SplitPlay and rewind the audio to replay the argument while the video is running at normal speed.

### EXAMPLE 3

A consumer who is shopping for a new car watches a live TV programme that mostly consist of “talking heads”. They use the SplitPlay feature to browse the visual part of car advertisements that are stored in the PDR. They are still able to monitor the progress of the programme through the audio part of the broadcast. At any given point can they switch forth and back between normal synchronized play and SplitPlay.

3.3. Broadening

The conscious design of stored multimedia content to utilize SplitPlay may become an important feature in educational programmes. The user is free to listen to an oral explanation while reviewing the visual parts of past events or searching ahead for cues to more relevant or interesting content. It may be combined with visual or audio hints and annotations that will help them navigate in the SplitPlay mode.

APPENDIX A
Two new suggested extension-sets for TVA Classification
Schemes - SplitPlayVideo (SPV) and SplitPlayAudio (SPA)

```
<ClassificationScheme uri=“urn:tva:metadata:cs:ActionTypeCS:2004”>
    <!-- ##################################################################### -->
    <!-- ACTIONTYPE EXTENSIONS-->
    <!-- Definition: Types of user action used to control SplitPlay actions-->
<!-- ##################################################################### -->
    <Term termID=“5”>
        <Name xml:lang=“en”> SplitPlayVideo </Name>
        <Definition xml:lang=“en”> Trickplay video with continuous audio </Definition>
        <Term termID=“5.1”>
            <Name xml:lang=“en”>SPV PlayRecording</Name>
            <Definition xml:lang=“en”> SPV Play video content from a recording</Definition>
        </Term>
        <Term termID=“5.2”>
            <Name xml:lang=“en”> SPV PlayStream</Name>
            <Definition xml:lang=“en”> SPV Play video content from input stream</Definition>
        </Term>
        <Term termID=“5.3”>
            <Name xml:lang=“en”> SPV Preview</Name>
            <Definition xml:lang=“en”>View a video summary of the input stream</Definition>
        </Term>
        <Term termID=“5.4”>
            <Name xml:lang=“en”> SPV Pause</Name>
            <Definition xml:lang=“en”> SPV Pause the video input stream</Definition>
        </Term>
        <Term termID=“5.5”>
            <Name xml:lang=“en”> SPV FastForward</Name>
            <Definition xml:lang=“en”> SPV Fast forward the video input stream</Definition>
        </Term>
        <Term termID=“5.6”>
            <Name xml:lang=“en”> SPV Rewind</Name>
            <Definition xml:lang=“en”> SPV Rewind the video input stream</Definition>
        </Term>
        <Term termID=“5.7”>
            <Name xml:lang=“en”> SPV SkipForward</Name>
            <Definition xml:lang=“en”> SPV Skip forward over a video portion of the input
        stream</Definition>
        </Term>
        <Term termID=“5.8”>
            <Name xml:lang=“en”> SPV SkipBackward</Name>
            <Definition xml:lang=“en”> SPV Skip backward over a video portion of the input
        stream</Definition>
        </Term>
        <Term termID=“5.9”>
            <Name xml:lang=“en”> SPV Loop/Repeat</Name>
            <Definition xml:lang=“en”> SPV Repeat/loop (part of) the video input
        stream</Definition>
        </Term>
        <Term termID=“5.10”>
            <Name xml:lang=“en”> SPV SkipToStart</Name>
            <Definition xml:lang=“en”> SPV Go to the beginning of the video stream</Definition>
        </Term>
        <Term termID=“5.11”>
            <Name xml:lang=“en”> SPV SkipToEnd</Name>
            <Definition xml:lang=“en”> SPV Go to the end of the video stream</Definition>
        </Term>
        <Term termID=“5.12”>
            <Name xml:lang=“en”>SPV SlowMotion</Name>
            <Definition xml:lang=“en”>SPV View input stream in slow motion</Definition>
        </Term>
        <Term termID=“5.13”>
            <Name xml:lang=“en”>SPV StepForward</Name>
            <Definition xml:lang=“en”>SPV Advance to next frame</Definition>
        </Term>
        <Term termID=“5.14”>
            <Name xml:lang=“en”>SPV StepBackward</Name>
            <Definition xml:lang=“en”>SPV Return to previous frame</Definition>
        </Term>
        <Term termID=“5.15”>
            <Name xml:lang=“en”>SPV VolumeUp</Name>
            <Definition xml:lang=“en”>SPV Increase volume</Definition>
        </Term>
        <Term termID=“5.16”>
            <Name xml:lang=“en”>SPV VolumeDown</Name>
            <Definition xml:lang=“en”>SPV Reduce volume</Definition>
        </Term>
        <Term termID=“5.17”>
            <Name xml:lang=“en”>SPA PlayAudioRecordingOnly</Name>
            <Definition xml:lang=“en”> SPA Play only audio content from a
        recording</Definition>
        </Term>
        <Term termID=“5.18”>
            <Name xml:lang=“en”> SPA PlayAudioStreamOnly</Name>
            <Definition xml:lang=“en”> SPA Play only audio content from input
        stream</Definition>
        </Term>
    </Term>
    <Term termID=“6”>
        <Name xml:lang=“en”> SplitPlayAudio </Name>
        <Definition xml:lang=“en”> Trickplay audio with continuous video </Definition>
        <Term termID=“6.1”>
            <Name xml:lang=“en”>SPA PlayRecording</Name>
            <Definition xml:lang=“en”> SPA Play audio content from a recording</Definition>
        </Term>
        <Term termID=“6.2”>
            <Name xml:lang=“en”> SPA PlayStream</Name>
            <Definition xml:lang=“en”> SPA Play audio content from input stream</Definition>
        </Term>
        <Term termID=“6.3”>
            <Name xml:lang=“en”> SPA Preview</Name>
            <Definition xml:lang=“en”>SPA View an audio summary of the input
        stream</Definition>
        </Term>
        <Term termID=“6.4”>
            <Name xml:lang=“en”> SPA Pause</Name>
            <Definition xml:lang=“en”> SPA Pause the audio input stream</Definition>
        </Term>
        <Term termID=“6.5”>
            <Name xml:lang=“en”> SPA FastForward</Name>
            <Definition xml:lang=“en”> SPA Fast forward the mute audio input
        stream</Definition>
        </Term>
        <Term termID=“6.6”>
            <Name xml:lang=“en”> SPA Rewind</Name>
            <Definition xml:lang=“en”> SPA Rewind the mute audio input stream</Definition>
        </Term>
        <Term termID=“6.7”>
            <Name xml:lang=“en”> SPA SkipForward</Name>
            <Definition xml:lang=“en”> SPA Skip forward over a mute audio portion of the input
        stream</Definition>
        </Term>
        <Term termID=“6.8”>
            <Name xml:lang=“en”> SPA SkipBackward</Name>
            <Definition xml:lang=“en”> SPA Skip backward over a mute audio portion of the
        input stream</Definition>
        </Term>
        <Term termID=“6.9”>
            <Name xml:lang=“en”> SPA Loop/Repeat</Name>
            <Definition xml:lang=“en”> SPA Repeat/loop (part of) the audio input
        stream</Definition>
        </Term>
        <Term termID=“6.10”>
            <Name xml:lang=“en”> SPA SkipToStart</Name>
            <Definition xml:lang=“en”> SPA Go to the beginning of the audio stream</Definition>
        </Term>
        <Term termID=“6.11”>
            <Name xml:lang=“en”> SPA SkipToEnd</Name>
            <Definition xml:lang=“en”> SPA Go to the end of the audio stream</Definition>
        </Term>
        <Term termID=“6.12”>
            <Name xml:lang=“en”>SPA VolumeUp</Name>
            <Definition xml:lang=“en”>SPA Increase volume</Definition>
        </Term>
        <Term termID=“6.13”>
            <Name xml:lang=“en”>SPA VolumeDown</Name>
            <Definition xml:lang=“en”>SPA Reduce volume</Definition>
        </Term>
        <Term termID=“6.14”>
            <Name xml:lang=“en”> SPA Fast Playback</Name>
            <Definition xml:lang=“en”> SPA Fast playback of the audio input stream</Definition>
        </Term>
        <Term termID=“6.15”>
            <Name xml:lang=“en”> SPA Slow Playback</Name>
            <Definition xml:lang=“en”> SPA Slow Playback of the audio input
        stream</Definition>
        </Term>
        <Term termID=“6.16”>
            <Name xml:lang=“en”>SPA PlayVideoRecording</Name>
            <Definition xml:lang=“en”> SPA Play video content from a recording</Definition>
        </Term>
        <Term termID=“6.17”>
            <Name xml:lang=“en”> SPA PlayVideoStream</Name>
            <Definition xml:lang=“en”> SPA Play video content from input stream</Definition>
        </Term>
    </Term>
```

1. A coding arrangement for independent presentation control of an audio part and a video part of an audio-visual programme content having metadata for presentation control of said audio-visual programme content, wherein at least one of said audio part or said video part being an independently retrievable part of an electronically stored programme content,
said coding arrangement comprising said metadata having at least one of a video-only related metadata part or an audio-only related metadata part.

2. The coding arrangement of claim 1, wherein said metedata having a video-only related metadata part and an audio-only related metadata part.

3. The coding arrangement of claim 2, wherein said video-only related metadata part being part of a recorded audio-visual programme content or part of a streaming audio-visual programme content and said audio-only related metadata part being part of said streaming audio-visual programme content.

4. The coding arrangement of claim 3, wherein said audio-only related metadata part comprising an audio presentation command being one of:
a) Continue playing only audio content from a recording, and
b) Continue Playing only audio content from input stream, and
said video-only related metadata part comprising a video presentation command being one of:
c) Play video content from a recording,
d) Play video content from input stream,
e) View a video summary of the input stream,
f) Pause the video input stream,
g) Fast forward the video input stream,
h) Rewind the video input stream,
i) Skip forward over a video portion of the input stream,
j) Skip backward over a video portion of the input stream,
k) Loop/Repeat, Repeat/loop (part of) the video input stream,
l) Go to the beginning of the video stream,
m) Go to the end of the video stream,
n) View input stream in slow motion,
o) Advance to next frame,
p) Return to previous frame,
q) VolumeUp, Increase volume in continuously playing audio stream, and
r) VolumeDown, Reduce volume in continuously playing audio stream.

5. The coding arrangement of claim 2, wherein said audi-only related metadata part being part of a recorded audio-visual programme content or part of a streaming audio-visual programme content and said video-only related metadata part being part of said streaming audio-visual programme content.

6. The coding arrangement of claim 5, wherein said video-only related metadata part comprising a video presentation command being one of:
a) Continue playing only video content from a recording, and
b) Continue playing only video content from input stream, and
said audio-only related metadata part comprising an audio presentation command being one of:
c) Play audio content from a recording,
d) Play audio content from input stream,
e) View an audio summary of the input stream,
f) Pause the audio input stream,
g) Fast forward the muted audio input stream,
h) Rewind the mute audio input stream,
i) Skip forward over an audio portion of the input stream,
j) Skip backward over an audio portion of the input stream,
k) Repeat/loop (part of) the audio input stream,
l) Go to the beginning of the audio stream,
m) Go to the end of the audio stream,
n) Increase volume,
o) Reduce volume,
p) Fast playback of the audio input stream, and
q) Slow Playback of the audio input stream.

7. An audio-visual media presentation device adapted to control a presentation of audio-visual programme content having metadata on basis of a coding arrangement of said meatadata, said device comprising a presentation controller being responsive to said coding arrangement of said meatadata to control independently an audio part and a video part of an audio-visual programme content wherein at least one of said audio part or said video part being an independently retrievable part of an electronically stored programme content, and
said coding arrangement comprising said metadata having at least one of a video-only related metadata part or an audio-only metadata part.

8. The device of claim 7, wherein said metadata comprising a video-only related metadata part and an audio-only metadata part.

9. The device of claim 8, wherein said video-only related metadata part being part of a recorded audio-visual programme content or part of a streaming audio-visual programme content and said audio-only related metadata part being part of said streaming audio-visual programme content.

10. The device of claim 9, wherein said audio-only related metadata part comprising an audio presentation command being one of:
a) Continue playing only audio content from a recording, and
b) Continue Playing only audio content from input stream, and
said video-only related metadata part comprising a video presentation command being one of:
c) Play video content from a recording,
d) Play video content from input stream,
e) View a video summary of the input stream,
f) Pause the video input stream,
g) Fast forward the video input stream,
h) Rewind the video input stream,
i) Skip forward over a video portion of the input stream,
j) Skip backward over a video portion of the input stream,
k) Loop/Repeat, Repeat/loop (part of) the video input stream,
l) Go to the beginning of the video stream,
m) Go to the end of the video stream,
n) View input stream in slow motion,
o) Advance to next frame,
p) Return to previous frame,
q) VolumeUp, Increase volume in continuously playing audio stream, and
r) VolumeDown, Reduce volume in continuously playing audio stream.

11. The device of claim 8, wherein said audi-only related metadata part being part of a recorded audio-visual programme content or part of a streaming audio-visual programme content and said video-only related metadata part being part of said streaming audio-visual programme content.

12. The device of claim 11 wherein said video-only related metadata part comprising a video presentation command being one of:
a) Continue playing only video content from a recording, and
b) Continue playing only video content from input stream, and
said audio-only related metadata part comprising an audio presentation command being one of:
c) Play audio content from a recording,
d) Play audio content from input stream,
e) View an audio summary of the input stream,
f) Pause the audio input stream,
g) Fast forward the muted audio input stream,
h) Rewind the mute audio input stream,
i) Skip forward over an audio portion of the input stream,
j) Skip backward over an audio portion of the input stream,
k) Repeat/loop (part of) the audio input stream,
l) Go to the beginning of the audio stream,
m) Go to the end of the audio stream,
n) Increase volume,
o) Reduce volume,
p) Fast playback of the audio input stream, and
q) Slow Playback of the audio input stream.
